(19) United States
(12) Patent Application Publication
(10) Pub. No.: US 2026/0180924 A1
(43) Pub. Date: Jun. 25, 2026

(54) PROGRAMMABLE EQUALIZATION IN CROSSBAR CHIPS FOR SIGNAL OPTIMIZATION

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/428,052

(22) Filed: Dec. 19, 2025

Related U.S. Application Data
(60) Provisional application No. 63/737,538, filed on Dec. 20, 2024.

(51) Int. Cl. H04L 49/101; H04L 41/0816; H04L 47/2416; H04L 47/2466

(52) U.S. Cl. CPC H04L 49/101; H04L 41/0816; H04L 47/2416; H04L 47/2466

(57) ABSTRACT

A device includes digital signal processors (DSPs) and analog crossbars in communication with the DSPs. The analog crossbars are operable to dynamically adjust equalization settings based on real-time feedback from DSPs, physical media-dependent (PMD) devices, or environmental sensors. Equalization adjustments optimize signal quality by compensating for traffic conditions, environmental changes, or signal degradation. The crossbars support predictive equalization using machine learning algorithms to preemptively adjust signal properties, ensuring performance across dynamic network environments. Diagnostics and logging capabilities monitor and refine equalization performance, while auxiliary in-band channels provide low-power pathways to reduce energy consumption. These features enable efficient, high-speed data transmission with enhanced reliability and adaptability in modern networking systems.

### RELATED APPLICATION

This application claims the benefit of U.S. Provisional Application No. 63/737,538, filed Dec. 12, 2024, the disclosure of which is incorporated herein by reference in its entirety.

The examples discussed in the present disclosure are related to programmable equalization in crossbar chips for signal optimization.

### BACKGROUND

Unless otherwise indicated herein, the materials described herein are not prior art to the claims in the present application and are not admitted to be prior art by inclusion in this section.

Datacenters and artificial intelligence (AI) clusters may use Ethernet switches that are packet switched. Using a packet switched Ethernet switch results in delivery that is not reliable, is variable, and has high latency. Fabric switches provide another possibility in datacenters and AI clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A system and device may include digital signal processors (DSPs) and analog crossbars that communicate to optimize signal quality dynamically. The analog crossbars and DSPs may each facilitate equalization adjustments based on real-time traffic conditions or environmental factors, such as network congestion, temperature fluctuations, or electromagnetic interference. These adjustments ensure signal integrity and reliable data transmission across diverse networking scenarios.

In some embodiments, a method involves connecting DSPs to analog crossbars and leveraging their combined functionality to adjust equalization settings dynamically. Feedback from system components, such as DSPs or physical media-dependent (PMD) devices, may be used to refine signal properties like frequency response, pre-emphasis, or de-emphasis. This collaborative process enables precise optimization of signal quality tailored to current operating conditions.

In some embodiments, the system, device and method may also include mechanisms for automated calibration during system startup or reconfiguration, as well as the ability to store pre-calibrated equalization profiles for rapid deployment. These features enhance the adaptability and efficiency of the system, reducing latency and energy consumption while maintaining high-speed data transmission and robust performance in complex network environments. In some embodiments, a method may include connecting digital signal processors to analog crossbars, and facilitating equalization based on one or more of a traffic condition or an environmental condition.

The objects and advantages of the examples will be realized and achieved at least by the elements, features, and combinations particularly pointed out in the claims. Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device including digital signal processors and analog crossbars.

FIG. 2 illustrates an example process flow for programmable equalization.

FIG. 3 illustrates an example communication system operable for programmable equalization.

FIG. 4 illustrates a diagrammatic representation of a machine in the example form of a computing device within which a set of instructions, for causing the machine to perform any one or more of the methods discussed herein, may be executed.

FIG. 5A illustrates an example block diagram of a data center.

FIG. 5B illustrates an example switch device.

FIG. 5C illustrates an example switch device.

FIG. 5D illustrates an example switch device.

### DESCRIPTION

The systems and methods of the examples described below pertains to the field of high-speed network switches and so-called physical media dependent (PMD) devices with crossbar-based architectures. Modern networks often experience fluctuating traffic patterns and congestion, requiring dynamic and efficient allocation of crossbar resources. Traditional static or fixed-path routing techniques lack the flexibility to respond to real-time network demands, often leading to inefficient bandwidth utilization and increased latency.

Programmable equalization focuses on signal quality optimization and may be used to fine tune performance. Crossbar chips may be used with programmable equalization settings to allow for real-time signal optimization based on traffic conditions and/or environmental factors.

Discussed in detail below, in some embodiments, a crossbar chip includes programmable equalization capabilities that allow for real-time signal optimization. These programmable settings are adjustable dynamically based on feedback from system components, such as digital signal processors (DSPs) or physical media-dependent (PMD) devices, as well as environmental sensors. By enabling continuous signal adjustment, the embodiments described herein improve data integrity and ensure reliable communication across diverse networking scenarios.

For example, in some embodiments, programmable equalization within a crossbar chip allows for fine-grained control of signal properties, such as frequency response, pre-emphasis, or de-emphasis. These settings may be distributed across the crossbar's inputs, outputs, or internal signal paths, ensuring that signals are optimized for their specific transmission. For example, applied in a high-traffic data center, the crossbar may increase pre-emphasis on specific paths to mitigate inter-symbol interference, while in low-traffic scenarios, equalization may be reduced to conserve energy.

Feedback-driven equalization ensures that adjustments are precise and responsive to real-time conditions. In some embodiments, DSPs provide continuous feedback on signal metrics such as bit error rate (BER), signal-to-noise ratio (SNR), and transmitter and dispersion eye closure quaternary (TDECQ). System 100 uses this feedback to update equalization settings dynamically, minimizing signal distortion and improving overall system performance.

In some embodiments, system 100 integrates environmental sensors to monitor external factors such as temperature, humidity, or electromagnetic interference. These sensors enable the crossbar to proactively adjust equalization settings to maintain optimal signal quality, even in challenging conditions. For instance, if a temperature spike causes increased signal attenuation, the crossbar may adjust its equalization profiles to counteract the effect

Examples of the described herein will be explained with reference to the accompanying drawings.

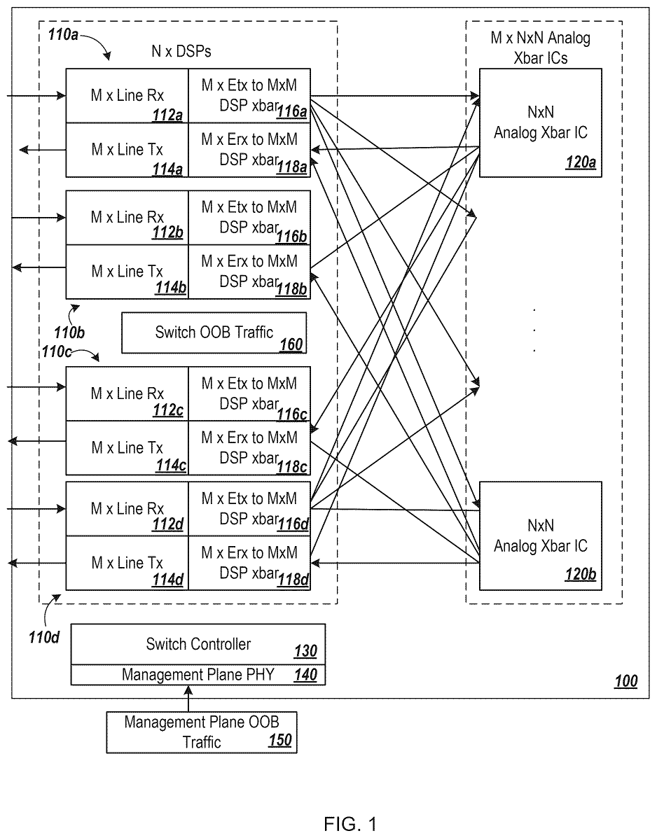

As illustrated in FIG. 1, an analog electrical circuit switch (AECS) 100 may include one or more digital signal processors (DSPs) 110a, 110b, 110c, 110d. The AECS 100 may include a switch controller 130. The AECS 100 may include one or more analog crossbars (“xbar”) integrated circuits (IC) (e.g., analog crossbars 120a, 120b).

DSPs 110a, 110b, 110c, 110d may be devices integrating layer 1 (L1) for line and switch side inputs and outputs. A DSP 110a may include an M×Line Rx 112a, an M×Line Tx 114a, an M×ETx to M×M DSP xbar 116a, and an M×ERx to M×M DSP xbar 118a. A DSP 110b may include an M×Line Rx 112b, an M×Line Tx 114b, an M×ETx to M×M DSP xbar 116b, and an M×ERx to M×M DSP xbar 118b. A DSP 110c may include an M×Line Rx 112c, an M×Line Tx 114c, an M×ETx to M×M DSP xbar 116c, and an M×ERx to M×M DSP xbar 118c. A DSP 110d may include an M×Line Rx 112d, an M×Line Tx 114d, an M×ETx to M×M DSP xbar 116d, and an M×ERx to M×M DSP xbar 118d. A DSP xbar may be a digital crossbar integrated in the DSP.

A PMD device may include a DSP 110a, 110b, 110c, 110d. The PMD may be an electrical-optical module or an electrical-electrical module.

A client may be a system communicating line-side in-band traffic to the AECS 100. For example, a server may be a system communicating line-side in-band traffic to the AECS 100.

Line-side in-band (IB) bandwidth may be line traffic communicated to or from a client. IB switch traffic may be IB traffic directed into or out of or within the AECS 100.

The switch controller (SC) 130 may manage and control AECS 100 devices. In one example, the switch controller 130 may be a microcontroller unit (MCU). Alternatively or in addition, the switch controller 130 may be a DSP 110a, 110b, 110c, 110d.

Switch out-of-band (OOB) traffic may be traffic among the SC 130, DSP 110a, 110b, 110c, 110d, analog crossbars 120a, 120b carried on a different network and physical layer than IB traffic. Switch OOB traffic may be carried on analog crossbars 120a, 120b with redundancy.

An “Xbar IC” may be an analog Xbar IC which may be a chip implementing an analog crossbar with input and output lanes.

Management plane OOB traffic may be traffic from outside the AECS 100 via management plane physical layer (PHY) to configure and manage the AECS 100.

A device may include DSPs and analog crossbars in communication with DSPs. The analog crossbars may facilitate equalization based on one or more of a traffic condition or an environmental condition. Analog crossbars may adjust signal quality based on feedback from DSPs. The analog crossbars may be positioned on an analog crossbar chip. The analog crossbar chip may support programmable equalization which may allow the device to dynamically optimize signal quality based on real-time feedback from the network, which is described in further detail below.

Various kinds of equalization may be implemented. For example, a linear equalizer (such as minimum mean square error (MMSE), or a zero-forcing equalizer), a decision feedback equalizer (DFE), a blind equalizer, adaptive equalization (e.g., which may be a linear equalizer or a DFE), a Viterbi equalizer, a Bahle-Cocke-Jelinek-Raviv equalizer, a turbo equalizer, or the like may be implemented.

The programmable equalization may be distributed at the inputs, outputs, internal amplifiers, stand-alone passives, or the like. For example, equalization may be performed at the receiver or may be performed at the transmitter. Linearization may be performed on the transmitter. Equalization may be performed in the crossbar between DSPs and analog crossbars. The equalization may be jointly optimized using a feedback process. Equalization may be set by an on-chip controller (e.g., a switch controller) or an off-chip controller. Equalization may vary based on the crossbar configuration. The equalization may be calibrated and/or optimized for different crossbar configurations by an on-chip controller (e.g., a switch controller) or an off-chip controller.

Analog crossbars may dynamically adjust a signal property to optimize transmission across a crossbar. The signal properties may include, for example, frequency response or pre-emphasis, which is described in detail below.

In some embodiments, system 100 implements methods for dynamically adjusting signal properties to optimize transmission. For example, pre-emphasis may be applied to boost higher-frequency components of a signal that would otherwise attenuate over long distances. Similarly, de-emphasis may be used to reduce the impact of high-frequency noise. These adjustments can be tailored to individual signal paths within the crossbar, enabling precise optimization for each connection.

The dynamic nature of these adjustments is particularly beneficial in systems where traffic patterns are highly variable. In some embodiments, system 100 monitors traffic conditions and identifies paths with increased congestion or higher error rates. Equalization settings for these paths can then be updated in real time to reduce data loss and improve throughput.

In some embodiments, system 100 incorporates energy efficiency strategies to reduce power consumption during dynamic signal adjustment. These strategies include selectively enabling or disabling equalization features based on real-time traffic conditions and signal. For example, in low-traffic scenarios or during periods of stable environmental conditions, the system may operate with minimal equalization to conserve energy while maintaining adequate signal quality.

In some embodiments, system 100 may scale the intensity of equalization adjustments dynamically. For instance, high-power equalization settings such as maximum pre-emphasis may be applied only to paths experiencing significant signal degradation, while paths with minimal issues operate at reduced power levels. This targeted application of resources minimizes unnecessary energy expenditure.

Auxiliary in-band channels, described in detail below, also contribute to energy efficiency by providing low-power pathways for nearest-neighbor communication. These channels reduce the reliance on full equalization processing for short-distance transmissions, further lowering power consumption without compromising performance.

In some embodiments, system 100 may include integrated power monitoring sensors to track energy usage across equalization components. Feedback from these sensors allows the system to evaluate the trade-offs between power consumption and signal quality, enabling real-time adjustments to achieve an optimal balance. For example, during peak traffic periods, the system may prioritize performance over energy savings, while in off-peak hours, it may adopt a power-conserving mode.

In some embodiments, energy efficiency is enhanced through predictive traffic management. Machine learning algorithms, as previously discussed, can anticipate periods of low traffic or stable conditions and adjust equalization settings accordingly. This proactive approach maximizes energy savings while ensuring that the system remains ready to handle fluctuations in demand.

For example, in some embodiments, the crossbar chip integrates machine learning algorithms to enhance the precision and responsiveness of equalization adjustments. Such algorithms analyze historical and real-time data collected from DSPs, PMD devices, and environmental sensors to identify patterns and predict potential signal degradation scenarios. For example, machine learning models may be trained to recognize correlations between increased network traffic and signal attenuation or identify environmental conditions that frequently lead to higher error rates.

Predictive equalization adjustments leverage these insights to preemptively optimize signal properties, reducing the reliance on reactive changes that could introduce latency or temporary signal degradation. For instance, if a model predicts that a specific crossbar path will experience interference during a peak traffic period, the system may proactively apply equalization settings tailored to mitigate the anticipated distortion. This capability ensures performance, even in highly dynamic or unpredictable network environments.

The machine learning algorithms may operate locally on the crossbar chip or through a centralized controller that manages multiple devices in a network. In some embodiments, the algorithms are continuously updated using new data, improving their accuracy and adaptability over time. This iterative learning process enables the system to remain effective as network conditions and configurations evolve.

In some embodiments, crossbar chips with programmable equalization include automated signal calibration processes. During system startup or reconfiguration, the chip may initialize its equalization settings by performing an automated calibration sequence. This sequence may involve transmitting test signals across the crossbar and measuring metrics such as amplitude, timing jitter, and SNR. Based on these measurements, the crossbar generates an optimized equalization profile for each path.

The programmable equalization capabilities described herein provide several advantages over traditional static methods. In some embodiments, the ability to adjust equalization settings in real time ensures that signal quality is maintained across varying network conditions, reducing error rates and improving system reliability. Feedback-driven adjustments enhance precision, while automated calibration simplifies system maintenance and optimizes performance during startup or reconfiguration.

By integrating environmental sensors and leveraging dynamic signal adjustment techniques, crossbar chips with programmable equalization are adaptable to a wide range of applications, from data centers to telecommunications infrastructure. These features enable high-speed, high-reliability data transmission, positioning programmable equalization as an advancement in modern networking technology

In some embodiments, automated calibration may also occur periodically or in response to specific events, such as a hardware reset or a detected change in traffic patterns. In some embodiments, pre-calibrated equalization profiles are stored in non-volatile memory, allowing the crossbar to quickly apply these settings during re-initialization or failover scenarios. This approach minimizes downtime and ensures signal quality across reconfigurations.

The analog crossbars may adjust an equalization setting based on feedback from one or more of a DSP, a PMD, another component, or the like. The analog crossbars may use feedback from these system components to adjust and optimize equalization settings. Implementing programmable equalization within the analog crossbar chips may allow for adjustments in signal quality in real time based on feedback from DSPs and/or other sensors, which is described in detail further below.

The analog crossbars may adjust an equalization setting during one or more of a system startup or a system reconfiguration. Adjusting equalization settings during one or more of system startup or a system reconfiguration may facilitate optimal performance.

In addition or alternatively, the analog crossbars may store an equalization setting for different crossbar connections. By storing an equalization setting for different crossbar connections, the latency when switching between different crossbar connections may be reduced when compared to switching when an equalization setting for different crossbar connections is not store. The state of crossbar connections may be set by an on-chip controller and/or an off-chip controller. Non-volatile (NV) memory may store the state of crossbar connections and equalization. The AECS and/or DSP may have a look-up table (LUT) which may store the equalization settings for different crossbar connections (e.g., crossbar settings) in order to speed up acquisition and tracking when switching from one connection to another.

As mentioned above, system 100 may include an auxiliary in-band channel operable to reduce equalization usage without reducing signal quality. The auxiliary in-band channel may be used to communicate with the nearest neighbors. In some embodiments, a separate wire may be used to connect nearest-neighbor auxiliary in-band lanes, which is discussed in detail further below. The nearest neighbors may have a clear channel with the device. The clear channel may allow for reduced physical layer processing to facilitate reduced power, reduced latency, and/or reduced equalization.

An equalization setting may be adjusted based on channel performance feedback. Equalization may be optimized with feedback from channel performance of end-point DSPs. Some of the channel performance feedback may include e.g., bit error rate (BER), signal-to-noise ratio (SNR), transmitter dispersion and eye closure quaternary (TDECQ), or the like. The equalization setting may be adjusted synchronously. Alternatively or in addition, the equalization setting may be adjusted asynchronously, which is described in detail further below.

Programmable equalization may be implemented in DSPs. A device may include DSPs and analog crossbars in communication with DSPs. DSPs may facilitate equalization based on one or more of a traffic condition or an environmental condition. The DSPs may implement the functionality that has been described for analog crossbars in relation to programmable equalization.

Programmable equalization may be implemented by a switch controller. A device may include DSPs, analog crossbars in communication with DSPs, and a switch controller. The switch controller may facilitate equalization based on one or more of a traffic condition or an environmental condition. The switch controller may implement the functionality that has been described for analog crossbars in relation to programmable equalization.

In addition or alternatively, the AECS may be an optical circuit switch (OCS). Thus, any technique suitable for an AECS may be applied to an OCS.

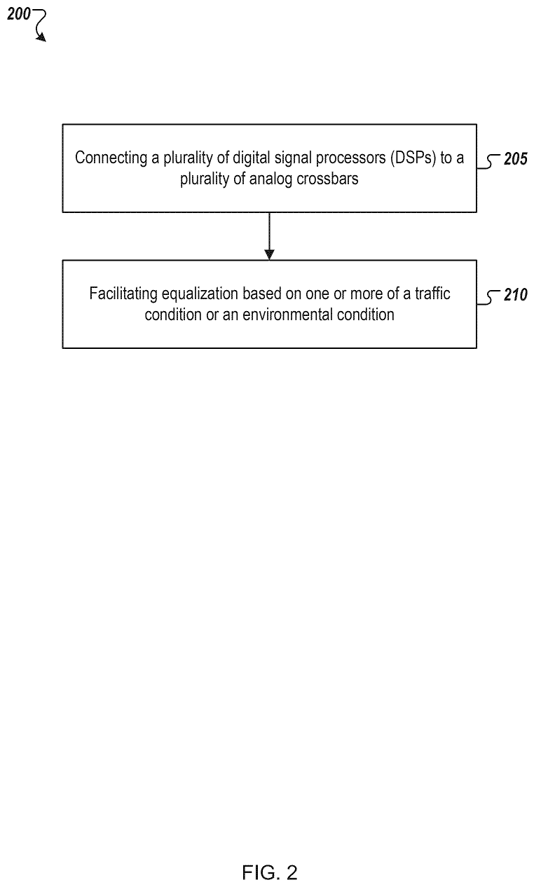

FIG. 2 illustrates a process flow of an example method 200 for programmable equalization, in accordance with at least one example described in the present disclosure. The method 200 may be arranged in accordance with at least one example described in the present disclosure.

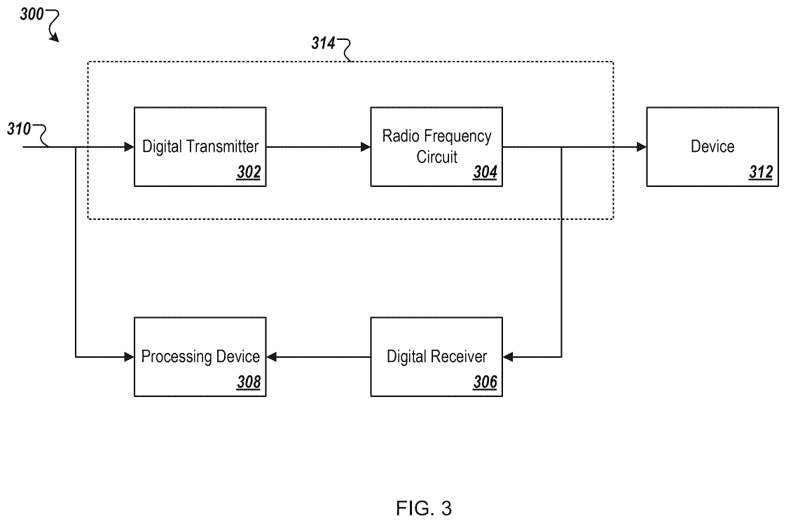

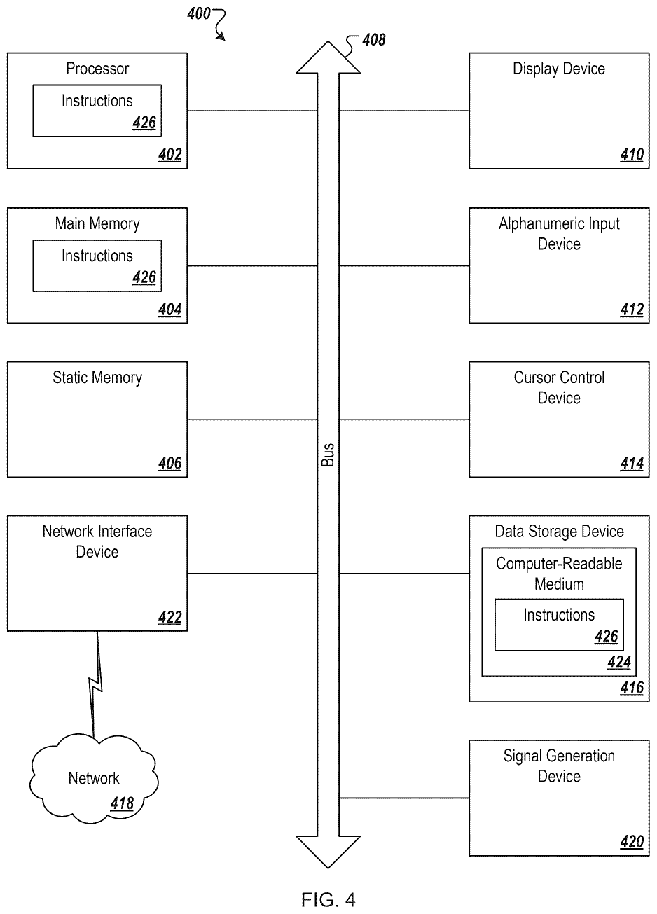

The method 200 may be performed by processing logic that may include hardware (circuitry, dedicated logic, etc.), software (such as is run on a computer system or a dedicated machine), or a combination of both, which processing logic may be included in the processing device 402 of FIG. 4, the communication system 300 of FIG. 3, or another device, combination of devices, or systems.

The method 200 may begin at block 205 where the processing logic may connect DSPs to analog crossbars.

At block 210, the processing logic may facilitate equalization based on one or more of a traffic condition or an environmental condition.

The processing logic may adjust signal quality based on feedback from the plurality of DSPs. The processing logic may adjust dynamically a signal property to optimize transmission across a crossbar. The processing logic may adjust an equalization setting based on feedback from one or more of a DSP or a physical media dependent (PMD) device. The processing logic may adjust an equalization setting during one or more of a system startup or a system reconfiguration. The processing logic may store an equalization setting for a plurality of crossbar connections. The processing logic may adjust an equalization setting based on channel performance feedback. The processing logic may adjust the equalization synchronously. The processing logic may adjust the equalization asynchronously.

In some embodiments, equalization feedback from system components such as DSPs, physical media-dependent (PMD) devices, and other sensors plays an advantageous role in maintaining optimal signal quality. Each feedback source provides metrics and insights, enabling the system to fine-tune equalization settings with precision. DSPs, for example, are responsible for monitoring real-time traffic conditions and signal integrity metrics such as bit error rate (BER), signal-to-noise ratio (SNR), and transmitter and dispersion eye closure quaternary (TDECQ). This feedback is particularly useful for detecting patterns of inter-symbol interference or timing jitter, allowing the system to adjust equalization settings dynamically to mitigate these effects.

For example, in some embodiments, the crossbar chip includes advanced diagnostics to monitor the performance of programmable equalization settings. Diagnostics may measure metrics such as bit error rate (BER), signal-to-noise ratio (SNR), timing jitter, eye openings, or histograms, and power consumption across each crossbar path. These metrics are logged in real time and stored in a centralized database or local non-volatile memory for analysis.

The logging capabilities enable network administrators to review historical equalization performance and identify trends or recurring issues. For example, if a specific path experiences high error rates despite equalization adjustments, the logs may reveal underlying causes such as physical layer defects or environmental factors. This information can guide targeted maintenance or configuration updates, improving overall system reliability.

Diagnostics may also include real-time alerts triggered by significant deviations in equalization performance. For instance, if a signal path experiences a sudden increase in BER or timing jitter, the system can notify operators or initiate automated corrective actions, such as recalibrating the equalization settings or rerouting traffic through an alternate path. These alerts minimize downtime and reduce the risk of prolonged signal degradation.

In addition to performance monitoring, the diagnostic system can evaluate the effectiveness of equalization profiles applied during startup or reconfiguration. By comparing actual performance metrics against expected outcomes, the system can refine existing profiles or generate new ones to address specific use cases. This feedback loop ensures that equalization settings remain optimized for the system's operations.

In some embodiments, PMD devices contribute additional feedback focused on the physical layer of signal transmission. These devices monitor characteristics such as attenuation, signal reflection, and impedance mismatches caused by the transmission medium (e.g., fiber optics or electrical cables). Feedback from PMD devices enables the system to optimize equalization settings specific to the physical layer, addressing issues that may not be apparent from DSP metrics alone. For example, a PMD device can detect signal degradation due to long-distance transmission over fiber, prompting the system to increase pre-emphasis or adjust equalizer tap weights to compensate.

In some embodiments, environmental sensors embedded in system 100 provide another layer of feedback by monitoring external factors such as temperature, humidity, and electromagnetic interference. These sensors enable proactive adjustments to equalization settings before environmental conditions can significantly impact signal quality. For instance, a rapid temperature rise may cause increased signal attenuation; the system can respond by adjusting equalization profiles to maintain performance. This proactive approach minimizes latency and ensures uninterrupted data flow even in challenging environments.

The integration of multiple feedback sources ensures that equalization adjustments are comprehensive and precise. In some embodiments, the system consolidates feedback from DSPs, PMD devices, and environmental sensors into a unified decision-making process managed by the switch controller. The controller assigns weight to each source based on the specific issue being addressed. For example, during periods of high traffic, DSP feedback may be prioritized to reduce congestion-related errors, while PMD feedback takes precedence during long-distance transmissions.

In addition to real-time adjustments, feedback sources enable the creation of adaptive equalization profiles stored in non-volatile memory. These profiles are developed based on historical data from DSPs, PMD devices, and sensors, allowing the system to anticipate and preemptively address common signal degradation scenarios. For example, a specific crossbar path that frequently experiences interference at certain times of day may have a tailored profile applied during those periods, optimizing performance without requiring manual intervention.

Modifications, additions, or omissions may be made to the method 200 without departing from the scope of the present disclosure. For example, in some examples, the method 200 may include any number of other components that may not be explicitly illustrated or described.

As mentioned above, in some embodiments, auxiliary in-band channels may be utilized as additional communication pathways integrated into system 100 to provide targeted support for signal transmission and optimization. Auxiliary in-band channels may reduce the reliance on equalization without compromising signal quality. In some embodiments, auxiliary in-band channels may facilitate direct communication between nearest-neighbor devices, such as DSPs or crossbars, using a simplified and dedicated pathway. For example, instead of processing a signal through multiple equalization stages, the auxiliary channel can establish a direct, low-latency connection that bypasses conventional signal correction mechanisms. This approach is particularly advantageous in scenarios where signal degradation is minimal, such as short-distance transmissions within a localized cluster of DSPs.

In some embodiments, auxiliary in-band channels may operate over dedicated physical wires connecting nearest-neighbor devices, as described in FIG. 2. These clear channels allow for reduced physical layer processing, which in turn lowers power consumption, latency, and computational overhead. By minimizing the need for extensive equalization adjustments, the auxiliary channels optimize the system's overall energy efficiency while maintaining high signal fidelity. This is particularly useful in environments where minimizing power consumption is a priority, such as large-scale data centers or edge computing systems.

In some embodiments, under certain conditions, auxiliary in-band channels may be selectively activated or deactivated based on system. For example, when network traffic is low or localized to a specific zone, the system can prioritize auxiliary channels to handle the majority of transmissions. This reduces the demand on primary signal paths and the associated equalization workload, conserving energy and prolonging the operational lifespan of components. Conversely, during high-traffic periods or in instances of increased signal degradation, auxiliary channels may act as a supplemental pathway, alleviating congestion and ensuring performance across the system.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 3 illustrates a block diagram of an example communication system 300 configured for programmable equalization, in accordance with at least one example described in the present disclosure. The communication system 300 may include a digital transmitter 302, a radio frequency circuit 304, a device 312, a digital receiver 306, and a processing device 308. The digital transmitter 302 and the processing device may be configured to receive a baseband signal via connection 310. A transceiver 314 may comprise the digital transmitter 302 and the radio frequency circuit 304.

In some examples, the communication system 300 may include a system of devices that may be configured to communicate with one another via a wired or wireline connection. For example, a wired connection in the communication system 300 may include one or more Ethernet cables, one or more fiber-optic cables, and/or other similar wired communication mediums. Alternatively, or additionally, the communication system 300 may include a system of devices that may be configured to communicate via one or more wireless connections. For example, the communication system 300 may include one or more devices configured to transmit and/or receive radio waves, microwaves, ultrasonic waves, optical waves, electromagnetic induction, and/or similar wireless communications. Alternatively, or additionally, the communication system 300 may include combinations of wireless and/or wired connections. In these and other examples, the communication system 300 may include one or more devices that may be configured to obtain a baseband signal, perform one or more operations to the baseband signal to generate a modified baseband signal, and transmit the modified baseband signal, such as to one or more loads.

In some examples, the communication system 300 may include one or more communication channels that may communicatively couple systems and/or devices included in the communication system 300. For example, the transceiver 314 may be communicatively coupled to the device 312.

In some examples, the transceiver 314 may be configured to obtain a baseband signal. For example, as described herein, the transceiver 314 may be configured to generate a baseband signal and/or receive a baseband signal from another device. In some examples, the transceiver 314 may be configured to transmit the baseband signal. For example, upon obtaining the baseband signal, the transceiver 314 may be configured to transmit the baseband signal to a separate device, such as the device 312. Alternatively, or additionally, the transceiver 314 may be configured to modify, condition, and/or transform the baseband signal in advance of transmitting the baseband signal. For example, the transceiver 314 may include a quadrature up-converter and/or a digital to analog converter (DAC) that may be configured to modify the baseband signal. Alternatively, or additionally, the transceiver 314 may include a direct radio frequency (RF) sampling converter that may be configured to modify the baseband signal.

In some examples, the digital transmitter 302 may be configured to obtain a baseband signal via connection 310. In some examples, the digital transmitter 302 may be configured to up-convert the baseband signal. For example, the digital transmitter 302 may include a quadrature up-converter to apply to the baseband signal. In some examples, the digital transmitter 302 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 302.

In some examples, the transceiver 314 may include one or more subcomponents that may be used in preparing the baseband signal and/or transmitting the baseband signal. For example, the transceiver 314 may include an RF front end (e.g., in a wireless environment) which may include a power amplifier (PA), a digital transmitter (e.g., 302), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 304) of the transceiver 314 may be synchronized with the resource controller via the S-plane device, which may contribute to high-accuracy timing with respect to a reference clock.

In some examples, the transceiver 314 may be configured to obtain the baseband signal for transmission. For example, the transceiver 314 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 314 may be configured to generate a baseband signal for transmission. In these and other examples, the transceiver 314 may be configured to transmit the baseband signal to another device, such as the device 312.

In some examples, the device 312 may be configured to receive a transmission from the transceiver 314. For example, the transceiver 314 may be configured to transmit a baseband signal to the device 312.

In some examples, the radio frequency circuit 304 may be configured to transmit the digital signal received from the digital transmitter 302. In some examples, the radio frequency circuit 304 may be configured to transmit the digital signal to the device 312 and/or the digital receiver 306. In some examples, the digital receiver 306 may be configured to receive a digital signal from the RF circuit and/or send a digital signal to the processing device 308.

In some examples, the processing device 308 may be a standalone device or system, as illustrated. Alternatively, or additionally, the processing device 308 may be a component of another device and/or system. For example, in some examples, the processing device 308 may be included in the transceiver 314. In instances in which the processing device 308 is a standalone device or system, the processing device 308 may be configured to communicate with additional devices and/or systems remote from the processing device 308, such as the transceiver 314 and/or the device 312. For example, the processing device 308 may be configured to send and/or receive transmissions from the transceiver 314 and/or the device 312. In some examples, the processing device 308 may be combined with other elements of the communication system 300.

FIG. 4 illustrates a diagrammatic representation of a machine in the example form of a computing device 400 within which a set of instructions, for causing the machine to perform any one or more of the methods discussed herein, may be executed. The computing device 400 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 400 includes a processing device (e.g., a processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

Processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a DSP, network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one example, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 424 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

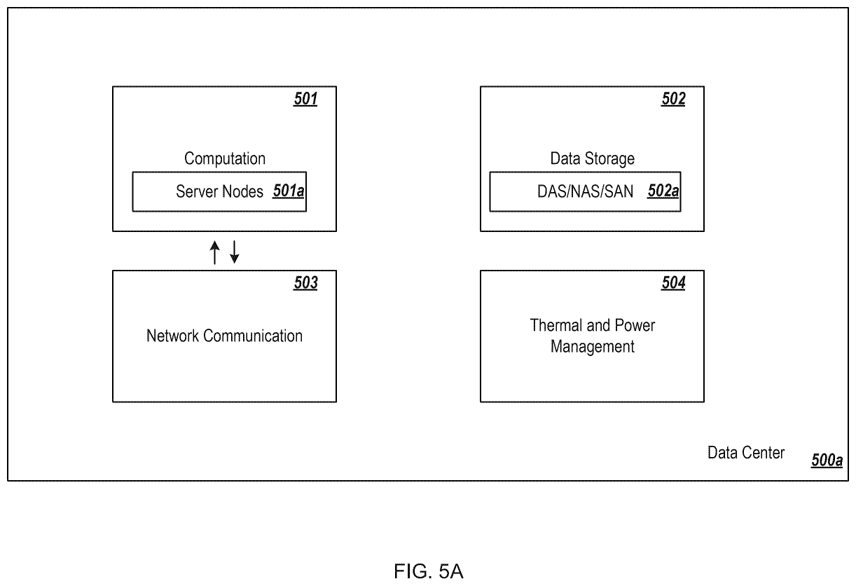

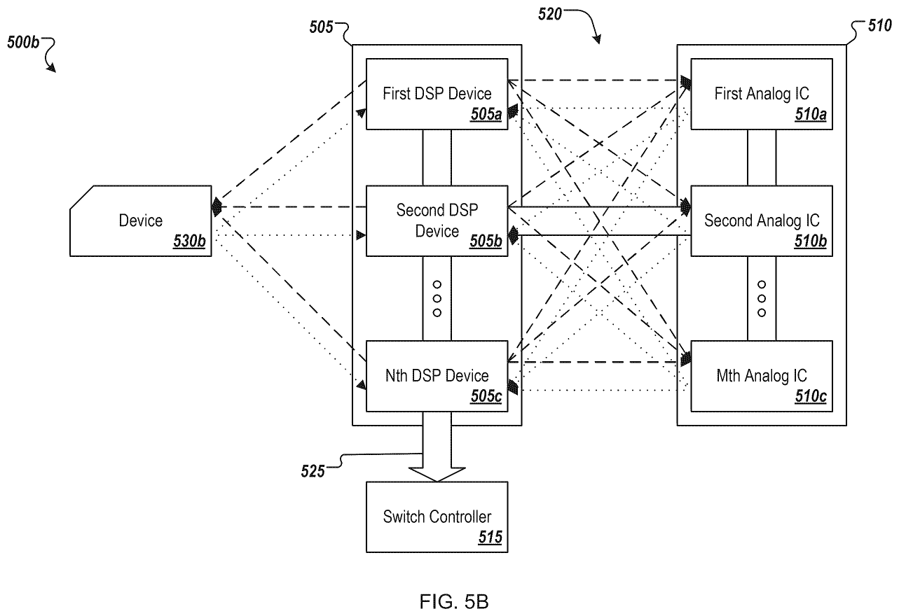

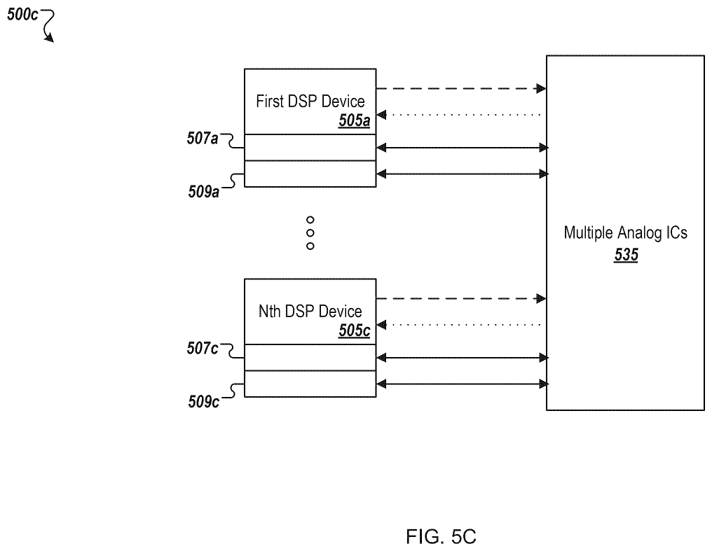

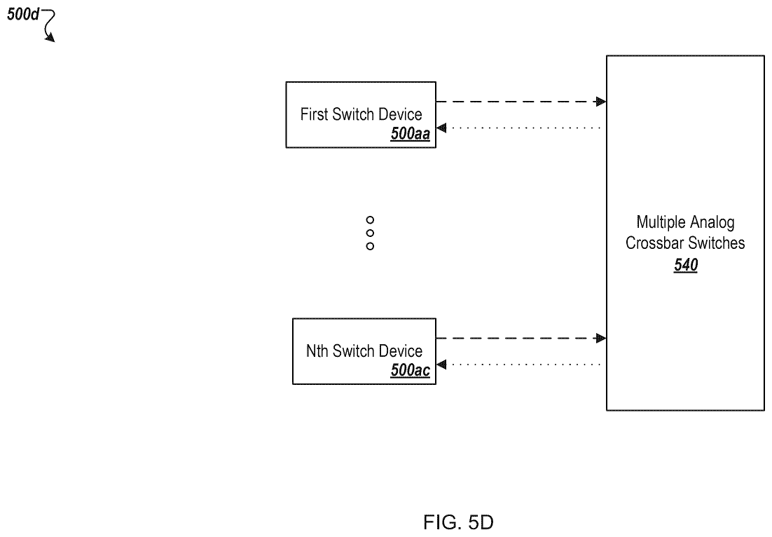

As illustrated in FIG. 5A, a block diagram of a data center 500a may include multiple subsystems configured to perform various operational functions, including computation 501, data storage 502, network communication 503, and thermal and power management 504. The computation 501 subsystem may include one or more server nodes 501a that may execute software applications and process data workloads. The data storage 502 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 502a. The networking communication 503 subsystem may facilitate bidirectional data transfer between servers and external networks through high-speed switching and routing components. The thermal and power management 504 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 500a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch system on chips (SOCs) with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 5B illustrates an example switch device 500b. The switch device 500b may include a first digital signal processor (DSP) device 505a, a second DSP device 505b, an nth DSP device 505c, referred to collectively as multiple first electronic devices 505, a first analog integrated circuit (IC) 510a, a second analog IC 510b, an mth analog IC 510c, referred to collectively as multiple second electronic devices 510, a switch controller 515, in-band traffic 520, and out-of-band traffic 525. First DSP 505a, second DSP 505b, and nth DSP 505c may have input and output.

The switch device 500b may be reconfigurable (e.g., in terms of the connections between the components therein, such as the multiple first electronic devices 505 and the multiple second electronic devices 510, the switch controller 515, and/or a device 530), where the switching of the connections/lanes between the components may be low latency (e.g., less than 5 ns, 10 ns, or the like switching). Alternatively, or additionally, the switch device 500b may reconfigure without the use of retiming such that each lane of the multiple lanes included therein may use less than 50 mW of power. For example, each lane of the multiple lanes may support 100 G bandwidth while using less than 50 mW of power.

The multiple first electronic devices 505 may individually include one or more ports that may be used to facilitate communications within the switch device 500b, such as between the multiple first electronic devices 505 and the multiple second electronic devices 510, the switch controller 515, and/or a device 530. The communications in the switch device 500b may be transmitted via multiple lanes in the switch device 500b. The multiple lanes may facilitate the in-band traffic 520 and/or the out-of-band traffic 525.

The multiple lanes between the multiple first electronic devices 505 and the multiple second electronic devices 510 may be in an any-to-any configuration. For example, the first DSP device 505a may include a lane to the first analog IC 510a, to the second analog IC 510b, and/or the mth analog IC 510c. A similar arrangement may occur for each of the multiple first electronic devices 505, such that each DSP device of the multiple first electronic devices 505 may include a lane to any number of the multiple second electronic devices 510, including none of the multiple second electronic devices 510. Each lane for facilitating the in-band traffic 520 may be in both directions (e.g., transmit and receive) between the multiple first electronic devices 505, the multiple second electronic devices 510, and/or a device 530. Alternatively, or additionally, the lanes are dashed/dotted to illustrate that for any transmit/receive path between the multiple first electronic devices 505, the multiple second electronic devices 510, and/or a device 530, a lane may or may not be present.

The multiple first electronic devices 505, the multiple second electronic devices 510, and/or the switch controller 515 may be disposed on a printed circuit board (PCB) where traces on the PCB may be used to connect at least the multiple first electronic devices 505, the multiple second electronic devices 510, and/or the switch controller 515 (e.g., the traces on the PCB may facilitate the in-band traffic 520 and/or the out-of-band traffic 525 in the switch device 500b). Alternatively, or additionally, the multiple first electronic devices 505, the multiple second electronic devices 510, and/or the switch controller 515 may be connected to one another using connectors, such as high-speed cables, where the multiple first electronic devices 505, the multiple second electronic devices 510, and/or the switch controller 515 may individually include ports/headers to support the use of the connectors. In instances in which the connectors are used, crosstalk between the multiple lanes in the switch device 500b may be reduced relative to the crosstalk that may occur when the switch device 500b uses traces on a PCB.

The switch device 500b, including the multiple first electronic devices 505, the multiple second electronic devices 510, and/or the switch controller 515, may be utilized with one or more additional switches and/or crossbar devices to form a new crossbar switch device, which may be larger than any one of the switch devices 500b. For example, as illustrated and discussed relative to FIG. 5C, the switch device 500b may be utilized with any other number of switch devices 500b (e.g., the nth switch device 500ac in FIG. 5C) and multiple analog crossbar switches 540 to form a new crossbar switch device.

The multiple first electronic devices 505 may be digital signal processors (DSPs) and/or the multiple second electronic devices 510 may be analog circuit switch integrated circuits (ICs) for use with electrical signals. Alternatively, or additionally the multiple second electronic devices 510 may be analog optical circuit switch ICs for use with optical signals. The multiple first electronic devices 505 may be individually configured to support one or more layer of the open systems interconnection (OSI) model. For example, each of the multiple first electronic devices 505 may be configured to support layer 1 protocols, layer 2 protocols, and/or layer 3 protocols with respect to the in-band traffic 520 and/or the out-of-band traffic 525.

Each, or at least one, of the multiple first electronic devices 505 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 505 may be able to adjust the way in which traffic is directed through it, such as in response to a command from the switch controller 515. For example, each of the multiple first electronic devices 505 may be operable to configure an internal switch, an external switch, or a crossbar based on the various layer protocol processing to be performed.

The first DSP device 505a may receive a communication that includes a frame header (or a packet header) and the first DSP device 505a may be configured to detect the frame header and decode the frame header along with any associated contents of the communication, all within the first DSP device 505a. In a second example, the first DSP device 505a may integrate a media access control (MAC) address lookup table which may allow the first DSP device 505a to configure one or more crossbars such that the first DSP device 505a may facilitate connectivity between any two MAC addresses that are included in the lookup table. Alternatively, or additionally, each of the first electronic devices 505 may include a lookup table that may store equalization settings that may be used for various connections between the first electronic devices 505 and other components within the switch device 500b. The equalization settings in the lookup table may be used to accelerate acquisition and/or tracking for a particular DSP device of the multiple first electronic devices 505 when the particular DSP device switches connections within the switch device 500b.

The multiple first electronic devices 505 may be configured to respond to layer 2 protocol requests and/or layer 3 protocol requests for connectivity and/or resource grant requests. For example, the multiple first electronic devices 505 may compare a request to a lookup table that includes priority levels and the multiple first electronic devices 505 may be operable to configure themselves and/or associated crossbars and/or switches based on the determined priority level. Alternatively, or additionally, each of the multiple first electronic devices 505 may be configured to respond to in-band requests (e.g., granting a connection request, signaling backpressure to the device 530, etc.), collect statistics on traffic handled by the multiple first electronic devices 505 (e.g., link utilization and/or traffic type), and/or perform data filtering (e.g., detecting a particular header, performing routing, generating flags and/or interrupts, and/or logging any of the filtering events).

The multiple first electronic devices 505 may be configured to communicate with (e.g., transmit data to and/or receive data from) the device 530. The communication with the device 530 may include in-band traffic 520. In such instances, the communications between the multiple first electronic devices 505 and the device 530 may be line-side communications, where the lines may facilitate communications using various communication channels. For example, the line-side communications between the multiple first electronic devices 505 and the device 530 may be an electrical-to-electrical connection, an optical-to-optical connection, an electrical-to-optical connection, or an optical-to-electrical connection, and so forth.

The device 530 may address communications directly to one of the multiple first electronic devices 505. For example, the device 530 may address communications to the second DSP device 505b. Alternatively, or additionally, the device 530 may address communications to the switch controller 515, which may then direct communications to the appropriate DSP device. For example, the device 530 may address communications intended for the second DSP device 505b to the switch controller 515 and the switch controller 515 may direct the communications to the second DSP device 505b.

The multiple first electronic devices 505 may individually include memory that may be used as a buffer for communications through the multiple first electronic devices 505. The memory in the multiple first electronic devices 505 may be utilized to buffer incoming and/or outgoing traffic, which may include in-band traffic 520 and/or out-of-band traffic 525. Due to the memory in the multiple first electronic devices 505 being distributed (e.g., by the distributed nature of the multiple first electronic devices 505), the switch device 500b may not include any memory for buffering in addition to the memory included in the multiple first electronic devices 505.

The multiple first electronic devices 505 may individually include one or more additional lanes that may be used for communications in the switch device 500b. Further details associated with the additional lanes are included in the description associated with FIG. 5C.

The multiple second electronic devices 510 may individually include one or more ports that may be used to facilitate communications within the switch device 500b, similar to the ports described relative to the multiple first electronic devices 505. Alternatively, or additionally, the lanes for communications between the multiple first electronic devices 505 and the multiple second electronic devices 510 may be coupled with the ports included in the multiple second electronic devices 510.

The switch controller 515 may be a microcontroller unit (MCU). Alternatively, or additionally, the switch controller 515 may be a DSP, or other processing device. The switch controller 515 may be communicatively coupled with at least the multiple first electronic devices 505 and/or the multiple second electronic devices 510. The switch controller 515 may resolve resource grant requests, distribute the network state to the multiple first electronic devices 505 and/or to the multiple second electronic device 510, and/or may establish and/or maintain timing among the components included in the switch device 500b.

The switch controller 515 may communicate with the multiple first electronic devices 505 and/or the multiple second electronic devices 510 using a separate connection/lane than the connections between the multiple first electronic devices 505 and the multiple second electronic devices 510. For example, the first connection between the multiple first electronic devices 505 and the multiple second electronic devices 510 may facilitate the in-band traffic 520 and the second connection between the switch controller 515 and the multiple first electronic devices 505 and/or the multiple second electronic devices 510 may facilitate the out-of-band traffic 525.

The out-of-band traffic 525 may use a different network than the in-band traffic 520. Alternatively, or additionally, the out-of-band traffic 525 may use a different physical layer protocol than the in-band traffic 520. The out-of-band traffic 525 may be used to manage and/or configure one or more components included in the switch device 500b. For example, the switch controller 515 may communicate with the multiple first electronic devices 505 using the out-of-band traffic 525 to reconfigure lanes and/or traffic routing based on the traffic through the switch device 500b.

The switch controller 515 may be programmable such that the switch controller 515 may be operable to dynamically map the lanes between the multiple first electronic devices 505 and the multiple second electronic devices 510. For example, in instances in which the first DSP device 505a includes a lane to the first analog IC 510a, the switch controller 515 may dynamically map the lane to be from the first DSP device 505a to the second analog IC 510b. The switch controller 515 may dynamically adapt the mapping of the lanes between the multiple first electronic devices 505 and the multiple second electronic devices 510 based on one or more conditions and/or a satisfaction of a threshold related to the conditions. For example, in instances in which the real-time data traffic in the switch device 500b (or an amount of real-time data traffic handled by one of the multiple first electronic devices 505 and/or one of the multiple second electronic devices 510) satisfies a threshold, the switch controller 515 may dynamically adapt the mapping of the lanes as described.

The switch device 500b may include one or more redundant lanes that may be used in various situations during operation of the switch device 500b. For example, one or more redundant lanes may be used for the out-of-band traffic 525, such as signaling using the out-of-band traffic 525. In such instances, the out-of-band signaling may be transmitted and/or received by a particular DSP device and/or by the switch controller 515, and the out-of-band signaling may be a lower transmission rate than the in-band traffic 520. In another example, one or more redundant lanes may be used for out-of-bandwidth broadcasts from the switch controller 515 and/or from one or more of the multiple first electronic devices 505 to other devices in the switch device 500b (e.g., such as other DSP devices).

The switch controller 515 may reserve a portion of bandwidth associated with the in-band traffic 520 in the switch device 500b. The bandwidth reserved by the switch controller 515 may be reserved on a per lane basis of the multiple lanes included in the switch device 500b. For example, a first lane between the first DSP device 505a and the first analog IC 510a may have a first reserved bandwidth and a second lane between the second DSP device 505b and the second analog IC 510b may have a second reserved bandwidth, where the amount of bandwidth reserved may be the same or may differ between the first reserved bandwidth and the second reserved bandwidth. The switch controller 515 may allocate resources within the switch device 500b based on predicted or anticipated traffic (e.g., based on a probabilistic model).

Alternatively, or additionally, the switch controller 515 may monitor the lanes of the multiple lanes in the switch device 500b. The switch controller 515 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 515 may dynamically remap a new lane in the switch device 500b to replace the degraded lane.

The switch controller 515 may perform adaptive signal equalization to the in-band traffic 520 in the switch device 500b. For example, the multiple first electronic devices 505 may provide feedback to the switch controller 515 relative to the workload handled by the multiple first electronic devices 505, and the switch controller 515 may adaptively manage workloads of the multiple first electronic devices 505 to optimize performance of the switch device 500b.

A backup switch controller (not illustrated) may be included in the switch device 500b. The backup switch controller may be a redundant controller relative to the switch controller 515. The backup switch controller may include the same or similar connections as the switch controller 515 relative to the multiple first electronic devices 505 and/or the multiple second electronic devices 510. The backup switch controller may perform the same or similar operations as the switch controller 515.

FIG. 5C illustrates an example switch device 500c. The switch device 500c may include a first DSP device 505a, an nth DSP device 505c, and multiple analog ICs 535. The first DSP device 505a may include a first auxiliary channel 507a, and a first out-of-band channel 509a. The nth DSP device 505c may include an nth auxiliary channel 507c, and an nth out-of-band channel 509c.

The first DSP device 505a, the nth DSP device 505c, and the multiple analog ICs 535 may be the same or similar as the first DSP device 505a, the nth DSP device 505c, and the multiple second electronic devices 510, respectively, of FIG. 5A and may be operable to perform the same or similar functions as described.

The auxiliary channels 507 (e.g., the first auxiliary channel 507a and the second auxiliary channel 507c) may be individually utilized by each of the DSP devices 505a, 505c as an additional lane for in-band traffic between at least the DSP devices 505a, 505c and the multiple analog ICs 535. The auxiliary channels 507 may be used to redundantly transmit in-band traffic relative to another lane included in the DSP devices 505a, 505c prior to a change in configuration to the corresponding DSP devices 505a, 505c. For example, in instances in which the first DSP device 505a includes a lane to a particular analog IC of the multiple analog ICs 535 and the first DSP device 505a is to be reconfigured (e.g., by a switch controller as described herein), the first auxiliary channel 507a may have a lane mapped to the particular analog IC such that the in-band traffic is redundant between the first DSP device 505a and the particular analog IC prior to reconfiguring the lanes associated with the first DSP device 505a (which reconfiguration may otherwise break the connection between the first DSP device 505a and the particular analog IC).

The auxiliary channels 507 may be used for communication between other near DSP devices. For example, in instances in which the first DSP device 505a is disposed spatially near to the nth DSP device 505c, the first DSP device 505a and the nth DSP device 505c may communicate with one another via the auxiliary channels 507. Such communications may be possible as the channels between near-neighbors may be relatively clean, such that physical layer processing may be simplified and may result in power reduction, latency reduction, a lesser amount of equalization, and/or other benefits to the switch device 500c.

The out-of-band channels 509 may be used to communicate the out-of-band traffic (e.g., the out-of-band traffic 525 of FIG. 5B) on a lane separate from the multiple lanes used to communicate in-band traffic. In such instances, the out-of-band channels 509 may not cause blocking or interference to the in-band traffic between at least the DSP devices 505a, 505c and the multiple analog ICs 535.

FIG. 5D illustrates an example aggregated switch device 500d. The aggregated switch device 500d may include a first switch device 500aa, an nth switch device 500ac, and multiple analog crossbar switches 540. The first switch device 500aa and the nth switch device 500ac may individually be the same or similar as the switch device 500b of FIG. 5B.

The aggregated switch device 500d illustrates that any number of the switch devices 500b (e.g., the first switch device 500aa and the nth switch device 500ac) may be aggregated into another switch device and/or connected to other analog crossbar switches. Each of the switch devices 500b may include multiple DSP devices and multiple analog IC and may be further aggregated into the aggregated switch device 500d using the multiple analog crossbar switches 540. As such, the aggregated switch device 500d may be scaled up or down for any size communication need, by adjusting the switch devices 500b and/or the multiple analog crossbar switches 540 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs); and
a plurality of analog crossbars in communication with the plurality of DSPs,
wherein the plurality of analog crossbars are operable to facilitate equalization by dynamically adjusting signal properties based on one or more of a traffic condition or an environmental condition.

2. The device of claim 1, wherein the plurality of analog crossbars are operable to adjust signal quality based on real-time feedback from the plurality of DSPs, physical media-dependent (PMD) devices, or environmental sensors.

3. The device of claim 1, wherein the plurality of analog crossbars are operable to dynamically adjust a signal property, including frequency response, pre-emphasis, or de-emphasis, to optimize transmission across a crossbar.

4. The device of claim 1, wherein the plurality of analog crossbars are operable to jointly optimize equalization settings through feedback received from a DSP or a physical media-dependent (PMD) device.

5. The device of claim 1, wherein the plurality of analog crossbars are operable to perform automated adjustments to equalization settings during one or more of a system startup, a system reconfiguration, or a failover event.

6. The device of claim 1, wherein the plurality of analog crossbars are operable to store pre-calibrated equalization settings in non-volatile memory for rapid application during re-initialization or crossbar reconfiguration.

7. The device of claim 1, further comprising an auxiliary in-band channel operable to facilitate nearest-neighbor communication, reducing equalization usage without reducing signal quality.

8. The device of claim 1, wherein an equalization setting is adjusted based on channel performance metrics, including bit error rate (BER), signal-to-noise ratio (SNR), timing jitter, eye openings, or histograms, received as feedback from system components.

9. The device of claim 1, wherein an equalization setting is adjusted synchronously in response to coordinated system updates or reconfigurations.

10. The device of claim 1, wherein an equalization setting is adjusted asynchronously to respond to localized changes in traffic conditions or environmental factors.

11. A method, comprising:
connecting a plurality of digital signal processors (DSPs) to a plurality of analog crossbars; and
facilitating equalization by dynamically adjusting signal properties based on one or more of a traffic condition or an environmental condition.

12. The method of claim 11, further comprising adjusting signal quality based on real-time feedback from the plurality of DSPs, physical media-dependent (PMD) devices, or environmental sensors.

13. The method of claim 11, further comprising, dynamically adjusting a signal property, including frequency response, pre-emphasis, or de-emphasis, to optimize transmission across a crossbar.

14. The method of claim 11, further comprising, determining an equalization setting through feedback received from one or more of a DSP or a physical media-dependent (PMD) device.

15. The method of claim 11, further comprising, determining adjustments to equalization settings during one or more of a system startup, a system reconfiguration, or a failover event.

16. The method of claim 11, further comprising storing pre-calibrated equalization settings in non-volatile memory for rapid application during re-initialization or crossbar reconfiguration.

17. The method of claim 11, further comprising adjusting an equalization setting based on channel performance metrics, including bit error rate (BER), signal-to-noise ratio (SNR), timing jitter, eye openings, or histograms.

18. The method of claim 11, further comprising adjusting the equalization synchronously in response to coordinated system updates or reconfigurations.

19. The method of claim 11, further comprising adjusting the equalization asynchronously to respond to localized changes in traffic conditions or environmental factors.

20. A device, comprising:
a plurality of digital signal processors (DSPs); and
a plurality of analog crossbars in communication with the plurality of DSPs,
wherein the plurality of DSPs are operable to facilitate equalization by dynamically adjusting signal properties based on one or more of a traffic condition or an environmental condition.
